(19) United States
(12) Patent Application Publication
(10) Pub. No.: US 2009/0214155 A1
(43) Pub. Date: Aug. 27, 2009

(54) Integrated optical modulator

(76) Inventors: Gayle Murdouch, County Durham (GB); Robert Andrew Miller, County Durham (GB)

Correspondence Address: Samuel J Haidle;Howard Attrorney, 39400 Woodwar Avenue, Suite 101, Bloomfield Hills, MI, 48304-5151, US

(21) Appl. No.: 11/920,219

(22) PCT Filed: Apr. 21, 2006
(86) PCT No.: PCT/GB2006/001470

§ 371 Date: Oct. 24, 2008

(30) Foreign Application Priority Data
May 11, 2005 (GB) 0509542.7

(51) Int. Cl. G02F 1/035; G02B 6/12

(52) U.S. Cl. 385/14

(57) ABSTRACT

An integrated optical modulator comprising: an insulating substrate (14); an insulating ridge extending upwardly from the substrate (14), the ridge comprising an electrically conducting layer (16) within the ridge above the substrate (14); an optical waveguide (18, 19) positioned on the ridge and extending down through the ridge to the conducting layer (16); an electrical contact (24, 25) on the optical waveguide; a travelling wave electrode (20, 21) on the upper surface of the substrate (14); and, an electrically conducting air-bridge (22, 23) extending from the electrical contact (24, 25) to the travelling wave electrode (20, 21).

The present invention relates to an optical modulator. More particularly, but not exclusively, the present invention relates to a optical modulator having an air-bridge extending from a travelling wave electrode on a substrate to an electrical contact on an optical waveguide on a ridge above the substrate.

Optical modulators are known. An optical modulator typically comprises an insulating substrate having an electrically conducting layer therein. Optical waveguides extend along the surface of the substrate and extend into the substrate to the conducting layer. Air-bridges extend from T-rails on the waveguides to travelling wave electrodes on the substrate.

It is known that in order to maximise the interaction between the microwave signal and the optical signal in the waveguide the propagation velocity in the two should be as close to equal as possible. The conducting layer below the substrate significantly increases the capacitance of the T-rails, slowing the propagation velocity of the microwave signal. This extends the bandwidth of the frequency response of the modulator. In addition, since the conducting layer is only a few microns away from the travelling wave electrode there is a danger of shorting to the travelling wave electrode.

Accordingly, the present invention provides an integrated optical modulator comprising:
an insulating substrate;
an insulating ridge extending upwardly from the substrate, the ridge comprising an electrically conducting layer above the substrate;
an optical waveguide positioned on the ridge and extending down through the ridge to the conducting layer;
an electrical contact on the optical waveguide;
a travelling wave electrode on the upper surface of the substrate; and,
an electrically conducting air-bridge extending from the electrical contact to the travelling wave electrode.

The modulator according to the invention lacks the conducting layer below the travelling wave electrode, reducing the transmission loss, unwanted capacitive effects, the risk of shorting and the simulation time for designing the modulator. It is also relatively simple to manufacture.

Preferably, the modulator comprises a plurality of electrical contacts on the optical waveguide, each electrical contact having an electrically conducting air-bridge extending to the travelling wave electrode.

The electrical contact can be a T-rail.

Preferably, the optical modulator comprises a plurality of optical waveguides on the ridge each optical waveguide extending down to the conducting layer, each optical waveguide having at least one electrical contact thereon, the modulator further comprising a corresponding number of travelling wave electrodes, the modulator further comprising air-bridges extending from each travelling wave electrode to the electrical contacts on the corresponding optical waveguide.

The optical modulator can comprise first and second optical waveguides on the ridge and first and second travelling wave electrodes, one on each side of the ridge, the first optical waveguide having at least one electrical contact on its upper surface and an air-bridge extending from the electrical contact to the first travelling wave electrode, the second optical waveguide having at least one electrical contact on its upper surface and an air-bridge extending from the electrical contact to the second travelling wave electrode.

The substrate can be a semi insulating GaAs substrate.

The electrically conducting layer can be an n-type doped epitaxial layer, preferably an n⁺ type epitaxial layer.

Preferably the electrically conducting layer is connected to an external electrical contact.

Preferably the ridge comprises a further insulating layer on the electrically conducting layer, sandwiching the electrically conducting layer between the further layer and the substrate.

The present invention will now be described by way of example only and not in any limitative sense, with reference to the accompanying drawings in which

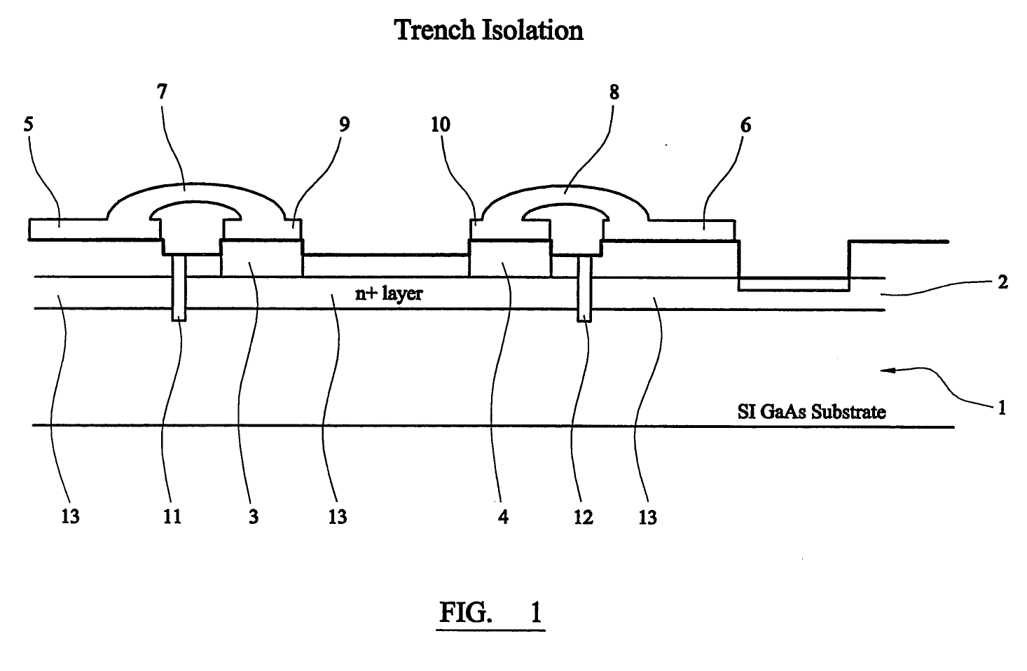

FIG. 1 shows a known optical modulator in cross section;

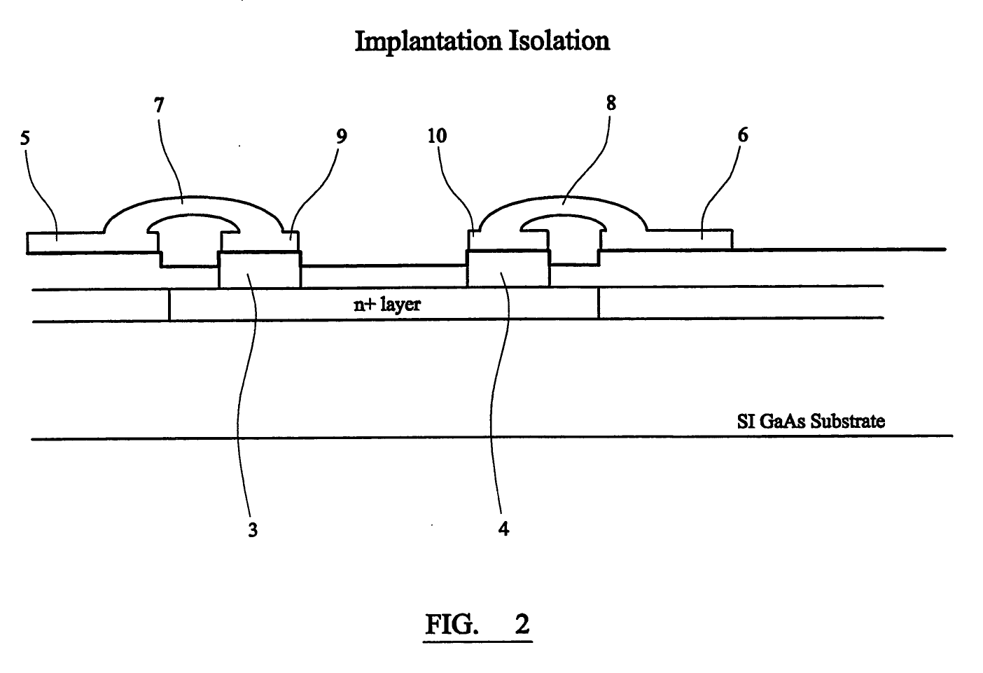

FIG. 2 shows a further known optical modulator in cross section;

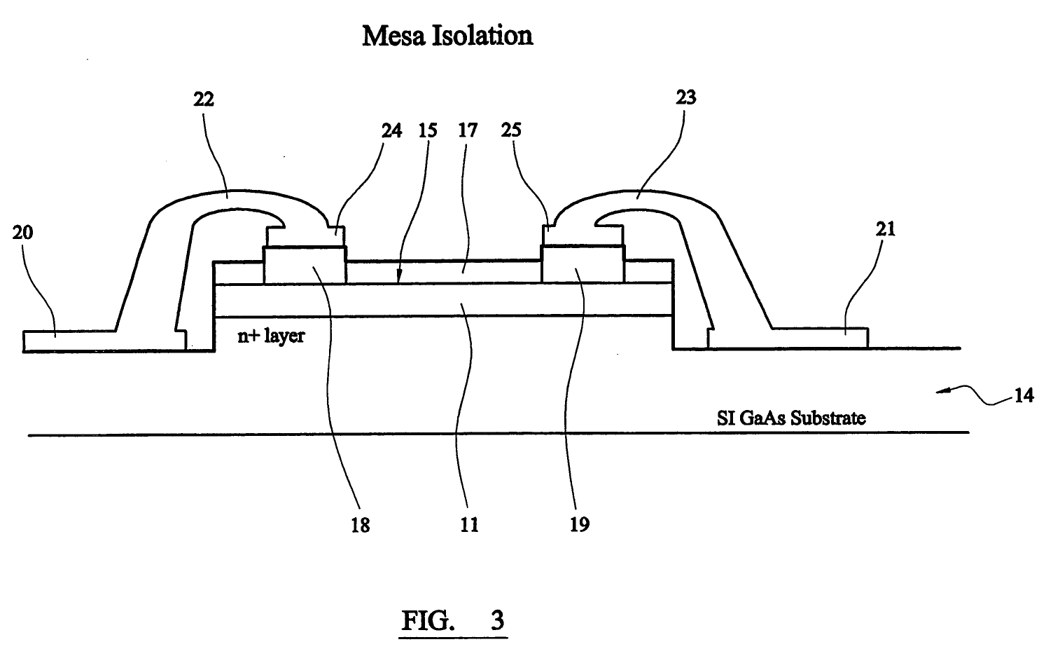

FIG. 3 shows a first embodiment of an optical modulator according to the invention;

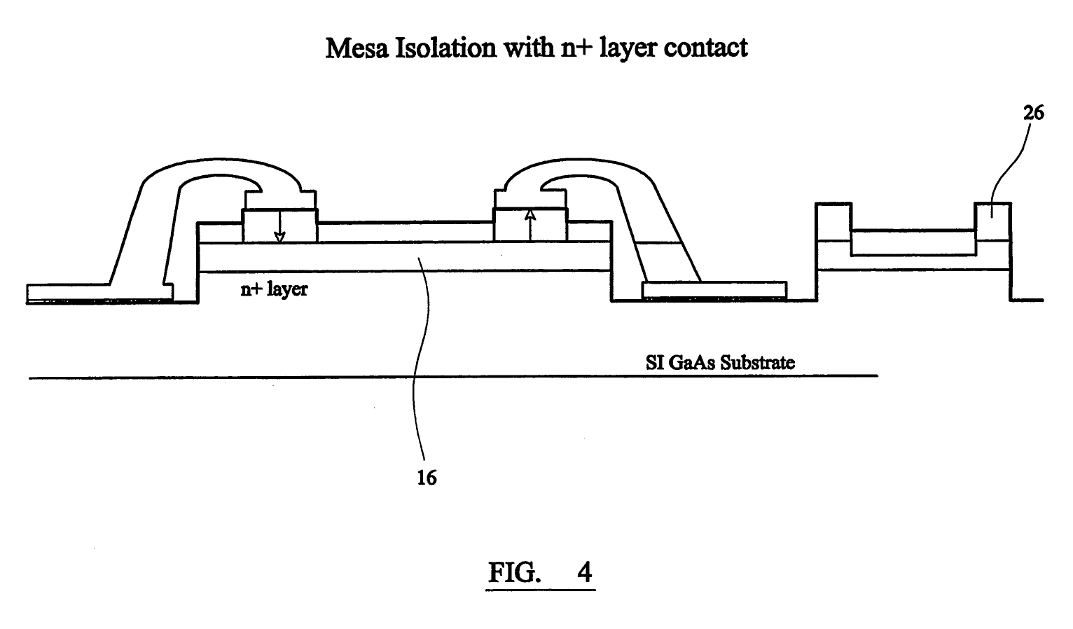

FIG. 4 shows a second embodiment of an optical modulator according to the invention.

Shown in FIG. 1 is a known optical modulator in cross section. The optical modulator comprises a semi insulating GaAs substrate (1) having a n⁺ conducting epitaxial layer (2) therein. First and second optical waveguides (3,4) are positioned on the substrate (1) above the n⁺ layer (4) and extend downwards into contact with the n⁺ layer (4). Associated with each optical waveguide (3,4) is a travelling wave electrode (5,6). An electrically conducting air-bridge (7,8) extends from each travelling wave electrode (5,6) to a T-rail (9,10) on the associated optical waveguide (3,4).

The n⁺ epitaxial layer (2) extends beneath the optical waveguides (3,4). Between each optical waveguide (3,4) and its associated travelling wave electrode (5,6) is an isolation trench (11,12). Each isolation trench (11,12) extends downwardly from the surface of the substrate (1) through the n⁺ layer (4) isolating the portion (13) of the n⁺ layer (4) below the travelling wave electrodes (5,6) from the portion (14) below the optical waveguides (9,10). The isolation trenches (11,12) reduce the capacitive effects of the n⁺ layer (4) on the T-rail (9,10) and also eliminate the risk of shorting. However, the n⁺ epitaxial layer (4) still exists beneath the travelling wave electrodes (5,6). This conducting layer (4) affects the transmission loss and impedance of the travelling wave electrodes (5,6), reducing the efficiency of the device.

Shown in FIG. 2 is a further known optical modulator in cross section. Rather than an isolation trench the n⁺ layer under the travelling wave electrodes (5,6) is neutralised by implanted ions. This however requires expensive ion implantation equipment. It also increases manufacturing costs and cycle time.

Shown in FIG. 3 is an embodiment of an optical modulator according to the invention in cross section. The optical modulator comprises a semi insulting GaAs substrate (14) having a ridge (15) extending upwardly therefrom. The ridge (15) comprises an n⁺ conducting layer (16) extending across the ridge (15) above the substrate (14). A further insulating layer (17) is positioned on the n⁺ conducting layer (16). Positioned on the ridge (15) are first and second optical waveguides (18,19). These waveguides (18,19) extend downwardly through the further-insulating layer (17) to the n⁺ conducting layer (16). Associated with each of the optical waveguides (18,19) are first and second travelling wave electrodes (20,21), one on each side of the ridge (15). The travelling wave electrodes (20,21) are positioned on the upper surface of the substrate (14). Electrically conducting air-bridges (22,23) extend from each of the travelling wave electrodes (20,21) to T-rails (24,25) on top of the associated optical waveguides (18,19).

As the conducting layer (16) does not extend beyond the central ridge (15) there is a minimal risk of a short circuit to either of the travelling wave electrodes (20,21). In addition, the conducting layer (16) also has a minimal effect on the transmission loss and characteristic impedance of the travelling wave electrodes (20,21). Using air as the dielectric for the metal connection also gives improved high frequency performance.

shown in FIG. 4 is a further embodiment of an optical modulator according to the invention. The optical modulator is similar to that of FIG. 3 except this central n⁺ conducting layer (16) is connected to an external electrical conductor (26).

1. An integrated optical modulator comprising:
an insulating substrate;
an insulating ridge extending upwardly from the substrate, the ridge comprising an electrically conducting layer above the substrate;
an optical waveguide positioned on the ridge and extending down through the ridge to the conducting layer;
an electrical contact on the optical waveguide;
a travelling wave electrode on an upper surface of the substrate; and,
an electrically conducting air-bridge extending from the electrical contact to the travelling wave electrode.

2. An optical modulator as claimed in claim 1, comprising a plurality of electrical contacts on the optical waveguide, each electrical contact having an electrically conducting air-bridge extending to the travelling wave electrode.

3. An optical modulator as claimed in claim 1, wherein the electrical contact is a T-rail.

4. An optical modulator as claimed in claim 1, comprising a plurality of optical waveguides on the ridge each optical waveguide extending down to the conducting layer, each optical waveguide having at least one electrical contact thereon, the modulator further comprising a corresponding number of travelling wave electrodes, the modulator further comprising air-bridges extending from each travelling wave electrode to the electrical contacts on the corresponding optical waveguide.

5. An optical modulator as claimed in claim 4, comprising first and second optical waveguides on the ridge and first and second travelling wave electrodes, one on each side of the ridge, the first optical waveguide having at least one electrical contact on an upper surface thereof and an air-bridge extending from the electrical contact to the first travelling wave electrode, the second optical waveguide having at least one electrical contact on an upper surface thereof and an air-bridge extending from the electrical contact to the second travelling wave electrode.

6. An optical modulator as claimed in claim 1, where the substrate is a semi insulating GaAs substrate.

7. An optical modulator as claimed in claim 1, where the electrically conducting layer is a n-type doped epitaxial layer.

8. An optical modulator as claimed in claim 1, where the electrically conducting layer is connected to an external electrical contact.

9. An optical modulator as claimed in claim 1, wherein the ridge comprises a further insulating layer on the electrically conducting layer, sandwiching the electrically conducting layer between the further layer and the substrate.

10-11. (canceled)

12. An optical modulator as claimed in claim 1, where the electrically conducting layer is an n⁺ type epitaxial layer.
